(19) United States
(12) Patent Application Publication
(10) Pub. No.: US 2007/0216238 A1
(43) Pub. Date: Sep. 20, 2007

(54) Self contained pump electrical equipment power supply integrated into sealing device

(75) Inventors: Eugene P. Sabini, Skaneateles, NY (US); Jerome A. Lorenc, Seneca Falls, NY (US); Oakley Henyan, Auburn, NY (US); Kenneth L. Hauenstein, Seneca Falls, NY (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: ITT Industries

(21) Appl. No.: 11/378,621

(22) Filed: Mar. 16, 2006

(51) Int. Cl. H02K 11/00

(52) U.S. Cl. 310/66; 417/313

(57) ABSTRACT

The invention provides a pumping system or other suitable rotating equipment having a self-contained pump electrical equipment power supply, featuring a shaft sealing device having an AC power generating device that form part of the self-contained pump electrical equipment power supply for supplying local AC electrical power to a circuit or other suitable pump instrumentation and monitoring equipment of the pumping system or other suitable rotating equipment. The sealing device may include a lip seal, packing, a laby seal, or a mechanical seal. The sealing device may also include an electrical connector that is used to connect the sealing device to the circuit or other suitable pump instrumentation and monitoring equipment. The circuit or other suitable pump instrumentation and monitoring equipment may include a circuit board that identifies a zero voltage crossing for speed, rectifies the AC voltage and regulates the DC voltage to required voltage levels needed for transducers, monitoring and communications equipment, or other suitable equipment.

### BACKGROUND OF THE INVENTION

1. Technical Field

The present invention generally relates to a pumping system or other rotational equipment; and more particularly to a pumping system or other rotational equipment having a power supply integrated into a sealing device of a pump in the pumping system.

2. Description of Related Problem

Pumping systems are known having the incorporation of a power generating device into part of a centrifugal pump bearing housing for the purpose of delivering electrical power at the pump site for pump instrumentation and monitoring equipment. See patent application Ser. No. 10/142,181, filed on 9 May 2002, entitled “Self contained Pump Electrical Equipment Power supply”, which is hereby incorporated by reference herein in its entirety.

A limitation of this technique is that it limits the generating device to only pumps. Therefore, the instrumentation, transducers and monitoring equipment cannot be used on other rotating equipment unless the power generating device is incorporated into the design of each piece of equipment.

There is a need in the art for a power generating device that can be integrated into pumps as well as other equipment.

Moreover, a patentability search was conducted on the present invention and various patents were developed in the search, which are summarized as follows:

One patent discloses a device for sensing temperature including piping and having a split ring clamp with a hole and an annular bead arranged in relation thereto, and also having a thermoelement with leads and extending through the hole. Another patent discloses a fluid machine having a controllable mechanical seal arranged in relation to a housing and a shaft and including an actuator of PZT material that responses to a signal from a control system to control the width of a gap between elements and. A third patent discloses an internal combustion engine having a combustion chamber defined by a piston, a cylinder, a cylinder head and a head gasket, which includes a core that acts as an ionization sensor. In operation, the leads provide sensed ionization information to a bus. A fourth patent discloses a seal having a seal body with an embedded conductor and leads. In operation, if the sealing body wears away to a certain point, then electricity stops flowing between the leads. A fifth patent discloses a cylinder head gasket having sensor elements for providing information about the crankshaft position in relation to the pistons. None of these patents developed in the search teach or suggest a shaft sealing device having an AC power generating device for supplying local AC electrical power to a circuit or other suitable pump instrumentation and monitoring equipment on the pump or other suitable rotating equipment, as set forth in your invention disclosure.

### SUMMARY OF THE INVENTION

In its broadest sense, the present invention provides a new and unique pumping system or other suitable rotating equipment having a self-contained pump electrical equipment power supply, featuring a shaft sealing device having an AC power generating device arranged therein for supplying local AC electrical power to power a circuit or other suitable pump instrumentation, transducers or monitoring equipment of the pumping system or other suitable rotating equipment. The AC power generating device forms part of the self-contained pump electrical equipment power supply.

The shaft sealing device may include a lip seal, packing, a laby seal, or a mechanical seal and is arranged on a drive shaft in relation to a pump in the pumping system or other suitable rotating equipment.

The shaft sealing device may also include an electrical connector that is used to connect the shaft sealing device to one or more circuits or modules in the pumping system or other suitable rotating equipment.

Either the pumping system or the circuit or other suitable pump instrumentation or monitoring equipment may include a circuit board or zero crossing module that identifies a zero voltage crossing for speed, rectifies the AC voltage and regulates the DC voltage to required voltage levels needed for instrumentation, transducers, monitoring and communications equipment, and/or other suitable equipment, consistent with that set forth in patent application Ser. No.______((911-2.18/04GI003) Express mail no. EV 711 305 943), entitled “Speed Indication for Pump Condition Monitoring,” filed on the same day as the instant patent application, which is hereby incorporated by reference in its entirety.

The present invention is rather simple, but to the inventors′ knowledge has never been tried, tested, developed or patented. Incorporated into a design of a shaft sealing device is the miniature AC power generating device. In addition to supplying local AC electrical power on any rotating piece of equipment that required a shaft sealing device, for transducers and monitoring equipment, also, if the circuits are incorporated the shaft rotational speed can be provided, as set forth in the aforementioned patent application.

As part of most rotating equipment, there is a need for some sort of shaft sealing device. The present invention deals with the broader application of the self power generating device incorporation into the laby/lip/mechanical seal device.

The foregoing and other objects, features and advantages of the present invention will become more apparent in light of the following detailed description of exemplary embodiments thereof.

### BRIEF DESCRIPTION OF THE DRAWING

The drawing is not drawn to scale and includes the following Figures:

FIG. 1 show a basic diagram of a pumping system or other suitable rotating equipment according to the present invention.

FIG. 2 show a diagram of an AC power generating device shown in FIG. 1 together with components of a power supply module also shown in FIG. 1 according to the present invention.

FIG. 3 shows the shaft sealing device 16 arranged on a shaft in the pumping system or other suitable rotating equipment shown in FIG. 1.

### BEST MODE FOR CARRYING OUT THE INVENTION

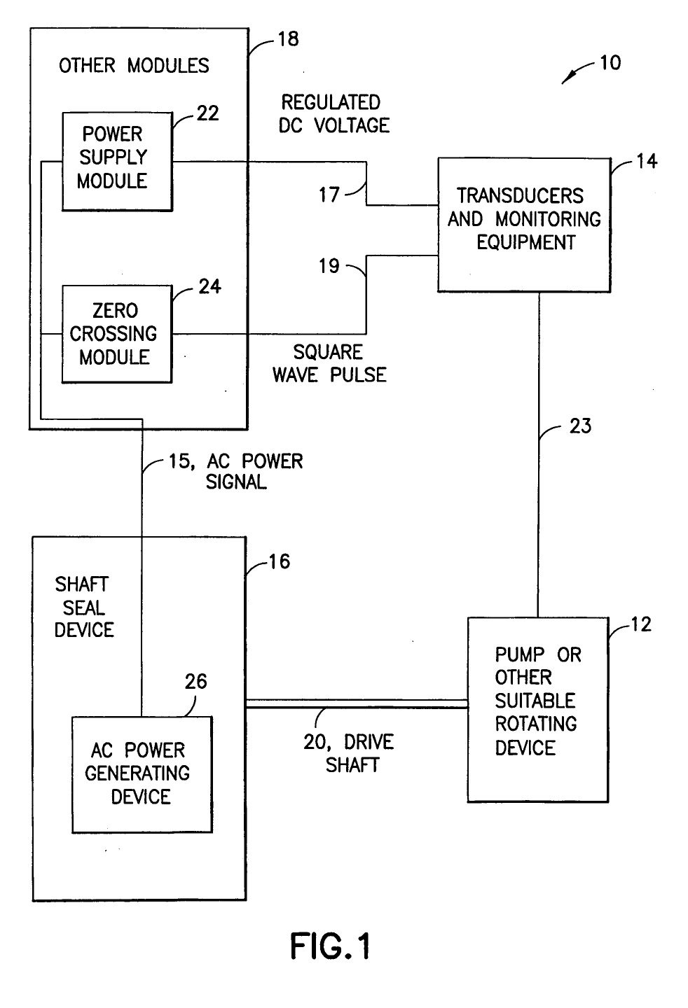

FIG. 1 shows, by way of example, a pumping system or other suitable rotating equipment generally indicated as 10, having a pump or other suitable rotating device 12, instrumentation, transducers, and/or monitoring equipment 14, a shaft sealing device 16 and other modules 18. The shaft sealing device 16 is arranged in relation to a drive shaft 20, and includes a self-contained pump electrical equipment power supply 26. The other modules 18 include a power supply module 22 and a zero crossing module 24. According to the present invention, the shaft sealing device 16 features an AC power generating device 26 arranged therein for supplying local AC electrical power along line 15 to power a circuit or other suitable pump instrumentation, transducers or monitoring equipment such as 14 of the pumping system or other suitable rotating equipment 10. The AC power generating device 26 and the power supply module 22 together form a self-contained pump electrical equipment power supply of the pumping system or other suitable rotating equipment 10.

The shaft sealing device 16 may take the form of a lip seal, packing, a laby seal, or a mechanical seal that is arranged on the drive shaft 20 in relation to the pump 12 in the pumping system or other suitable rotating equipment 10. Moreover, the scope of the invention is not intended to be limited to the aforementioned seals or sealing devices, because embodiments are envisioned using other seals or sealing devices either now known or later developed in the future.

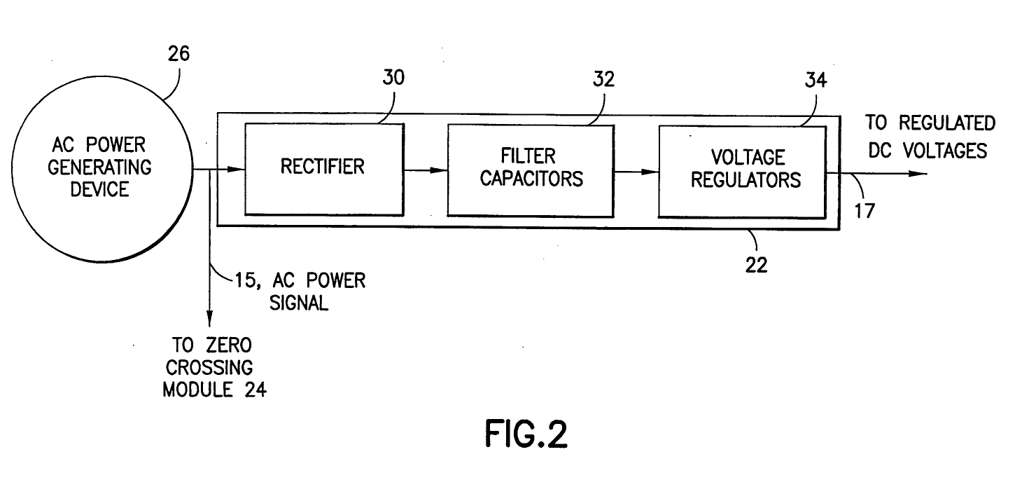

FIG. 2 shows the AC power generating device 26 (see also FIG. 1) together with the basic components of the power supply module 22 (see also FIG. 1). The AC power generating device 26 may include a stationary stator and rotating magnets that cooperate to provide the AC power signal in a manner that is known in the art and not described in detail herein. The scope of the invention is not intended to be limited to the type or kind of AC power generating device, and embodiments are envisioned using other types or kind of AC power generating device either now known or later developed in the future. As shown in FIGS. 1 and 2, the AC power generating device 26 provides the AC power signal to both the power supply module 22 and the zero crossing module 24 along the line 15. The basic components of the power supply module 22 include a rectifier 30, one or more filter capacitors 32 and one or more voltage regulators 34, which are all known in the art and shown and described in further detail in the aforementioned application Ser. No. 10/142,181. The invention is not intended to be limited to any particular type or kind of rectifier 30, filter capacitor 32 or voltage regulator 34. In operation, before being rectified, the AC power signal on line 15 from the AC power generating device 26 is directed to the zero crossing module 24 consistent with that described herein. The voltage regulator 34 provides a regulated DC voltage on line 17 to the transducers and monitoring equipment 14, although the scope of the invention is not intended to be limited to where the regulated DC voltage is provided or how it is used on the pumping system 10.

Many different types and kind of zero crossing modules and/or circuits 24 are known in the art, and the scope of the invention is not intended to be limited to any particular type or kind thereof either now known or later developed in the future. For example, a zero crossing module or circuit consistent with that shown and described in relation to the aforementioned patent application may be used herein. Based on an understanding of such known zero crossing modules and/or circuits, a person skilled in the art would be able to implement a zero crossing module and/or circuit such as 24 to perform functionality consistent with that shown and described herein, including identifying an instant of time the AC voltage crosses from one polarity to the other polarity and triggering a square wave pulse for each instant time. Embodiments are also envisioned in which the zero crossing module or circuit 24 is not a stand alone module, but instead forms part of the power supply module 22, or some other module including module 14 that forms part of the pumping system 10. In operation, the zero crossing modules and/or circuits 24 responds to the AC power signal on line 15, processes the same, and provides a square wave pulse on line 19. The processing includes, before being rectified, directing one phase of AC power through the zero crossing circuit or module 24 that identifies an instant of time the AC voltage crosses from one polarity to the other polarity and triggers a square wave pulse for each instant time. The AC voltage may be detected when it crosses from a negative polarity to a positive polarity, or vice versa.

Many different types and kind of instrumentation, transducers and/or monitoring equipment such as 14 for controlling and/or monitoring pumps are known in the art. Based on an understanding of such known modules, a person skilled in the art would be able to implement a module such as 14 to perform functionality consistent with that described herein, including measuring the period of the square wave pulse received on line 19, calculating the speed of the pump 12 or other rotating equipment based on the same, and/or controlling the basic operation of the pump 12 based on the same, for example, by providing a control signal along line 23. By way of example, the functionality of the control module 14 may be implemented using hardware, software, firmware, or a combination thereof, although the scope of the invention is not intended to be limited to any particular embodiment thereof. In a typical software implementation, such a module would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Consistent with that described above, embodiments are envisioned in which the zero crossing module 24 is implemented within element 14.

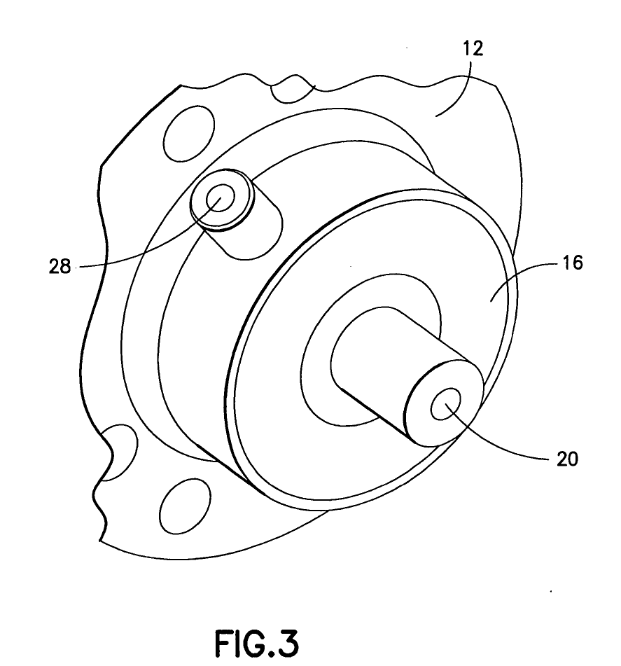

FIG. 3 shows the shaft sealing device 16 having an electrical connector 28 that is used to connect the shaft sealing device 16 via a coupling or connecting wire or wires (not shown) to one or more of the other modules 18. The scope of the invention is not intended to be limited to any particular type or kind of connecting or coupling device, or to what device or module the connector 28 to connected to, or how the connector 28 is connected to the same. Embodiments are envisioned using other types of connector or couplers either now known or later developed in the future.

### Other Applications

The present invention may used in relation to other pieces of rotating equipment such as gear boxes, fans, motors, compressors, crushers, virtually any piece of rotating equipment. To preserve the stand alone feature of the self-contained pump electrical equipment power supply, some type of local electrical power generation is required. The incorporation of a generating device into a shaft sealing device is an attractive, cost effective, least intrusive, low risk approach.

### The Scope of the Invention

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What is claimed is:

1. A pumping system or other suitable rotating equipment having a self-contained pump electrical equipment power supply, comprising:
a shaft sealing device having an AC power generating device arranged therein for supplying local AC electrical power to power a circuit, module or other suitable pump instrumentation, transducers or monitoring equipment of the pumping system or other suitable rotating equipment.

2. A pumping system or other suitable rotating equipment according to claim 1, wherein the shaft sealing device takes the form of a lip seal, packing, a laby seal, a mechanical seal or other suitable sealing device.

3. A pumping system or other suitable rotating equipment according to claim 1, wherein the shaft sealing device includes an electrical connector that is used to connect the shaft sealing device to one or more other circuits or modules in the pumping system or other suitable rotating equipment.

4. A pumping system or other suitable rotating equipment according to claim 1, wherein the pumping system or circuit or other suitable pump instrumentation or monitoring equipment may include a circuit board or zero crossing module that identifies a zero voltage crossing for speed, rectifies the AC voltage and regulates the DC voltage to required voltage levels needed for instrumentation, transducers, monitoring and communications equipment, and/or other suitable equipment.

5. A pumping system or other suitable rotating equipment according to claim 1, wherein the AC power generating device is a miniature AC power generating device.

6. A pumping system or other suitable rotating equipment according to claim 1, wherein the shaft sealing device is arranged on a drive shaft in relation to a pump in the pumping system or other suitable rotating equipment.

7. A pumping system or other suitable rotating equipment according to claim 1, wherein the AC power generating device forms part of the self-contained pump electrical equipment power.
